(19) United States
(12) Patent Application Publication
(10) Pub. No.: US 2007/0023984 A1
(43) Pub. Date: Feb. 1, 2007

(54) Link device that is deformable in substantially one direction only

(76) Inventor: Bjarne D. Hansen, Pontvallain (FR)

Correspondence Address: KENYON & KENYON LLP, 1500 K STREET N.W., SUITE 700, WASHINGTON, DC, 20005, US

(21) Appl. No.: 11/493,559

(22) Filed: Jul. 27, 2006

(30) Foreign Application Priority Data
Jul. 28, 2005 (FR) 0508059

(51) Int. Cl. F16F 1/26

(52) U.S. Cl. 267/261

(57) ABSTRACT

The present invention relates to a link device for connecting two parts together, the link device being deformable in substantially one direction only. The device comprises: two substantially identical elastically deformable plates, each plate having two opposite ends; and two spacer-forming elements for interconnecting the corresponding ends of the two plates and for keeping the plates substantially parallel when at rest, no other mechanical link existing between the two plates, and each part being suitable for being fastened to a respective one of the plates; whereby the two parts may be subjected to significant relative displacement along the direction orthogonal to the two plates while relative displacements between them are very limited along the other two directions of a Cartesian frame of reference.

The present invention relates to a link device for making a connection between two parts, the device being deformable in substantially one direction only.

In other words, the present invention relates to a device for accommodating manufacturing tolerances and alignment defects in a rigid mechanical assembly that may optionally be a moving assembly.

### BACKGROUND OF THE INVENTION

The link device enables the assembly to be kept rigid along axes where such rigidity is necessary, while in a preferred direction, its flexibility limits the forces on all of the components forming part of the assembly in the direction where lower rigidity is acceptable. Such a device is particularly useful in Cartesian displacement mechanisms along orthogonal axes in XRZ space as constituted by multiple and parallel mechanical guides and including rigid structures.

The function performed by such a device is usually implemented by means of mechanical linear guidance constituted, for example, by ball-cage shoes on a guide rail, ball-bushings on a shaft, or by contacting lubricated surfaces sliding along machine guide tracks.

Another solution is to make the mechanical mechanisms and assemblies that provide very accurate alignment in directions that are parallel or perpendicular to the movement axes so as to avoid imparting stresses that are unacceptable for the mechanisms.

Both of those two types of solution are relatively expensive.

### OBJECTS AND SUMMARY OF THE INVENTION

An object of the present invention is to provide a link device for interconnecting two parts that enables tolerances to be accommodated in a preferred direction, while ensuring that such accommodation is substantially excluded in other directions of the Cartesian frame of reference.

According to the invention, to achieve this object, the link device for connecting two parts together and that is deformable in substantially one direction only comprises:
two plane, substantially identical elastically deformable plates of thickness that is substantially constant in their deformable portions, each plate presenting two opposite ends; and
two spacer-forming elements for interconnecting the corresponding ends of the two plates while providing rigid end restraint and for holding them substantially parallel while at rest, no other mechanical link existing between the two plates, each part being suitable for being secured to a respective one of the plates;

whereby the two parts can move relative to each other significantly in the direction orthogonal to the two plates, while relative movements between them are very limited in the other two directions of a Cartesian frame of reference.

It will be understood that because of the deformability in bending of the two plates in a direction that is orthogonal to the plates, relative movements are possible between the two parts in this direction. In contrast, because of the end restraint at both ends of the two parallel plates, via the two spacer-forming elements, and because of the way the ends of the plates are connected to the spacer elements, it is practically impossible for deformation to take place in the two Cartesian directions contained in the plates, given the rigidity of the system in those two directions.

The term “spacer-forming” element should be understood as covering either spacers constituted by respective parts that are distinct from the plates, or else portions in relief provided at the ends of the plates.

The plates are preferably plane, and more preferably the plates are substantially rectangular.

Also preferably, the spacer elements interconnect the corresponding short sides of the two plates when they are rectangular, and more preferably the spacer elements extend over the full length of the short sides.

In a preferred embodiment, each spacer element is constituted by a strip of rigid material interposed between the two plates along their short sides, and the strips of material are secured to the plates by riveting, bolting, or welding.

Also preferably, each plate includes fastener means in the middle zone of its outside face for fastening to one of said parts, the part fastener means possibly comprising two rigid interface members respectively secured in the middle zone of each plate.

Another object of the invention is to provide a device for positioning the rear abutment of a press brake making use of link devices of the type defined above.

To achieve this object, the device for positioning the rear abutment of a press brake comprising two stationary cheek plates and a moving support for said abutment comprises two guide rails secured to said cheek plates parallel to a direction XX′, two second guide rails secured to each side of said support and parallel to a direction RR′ orthogonal to the direction XX′, two drive motor assemblies, each assembly being interposed between a first guide rail and a second guide rail, each assembly comprising a first drive member for moving said assembly relative to the first rail and a second drive member for moving said second rail relative to said assembly. In said device, each link assembly comprises a link device of the type defined above interposed between said first and second drive members in such a manner that said plates of the link support are parallel to the planes defined by the directions XX′ and RR′.

### BRIEF DESCRIPTION OF THE DRAWINGS

Other characteristics and advantages of the invention appear better on reading the following description of embodiments of the invention given as non-limiting examples. The description refers to the accompanying figures, in which:

FIG. 1A is an elevation view of the link device in simplified form;

FIG. 1B is a side view of the FIG. 1A link device;

FIG. 1C is an end view from above of the FIG. 1A link device;

FIG. 2 is a perspective view of the FIG. 1A link device;

FIG. 3 is a perspective view of the link device subjected to stress along the Z direction;

FIG. 4A is an elevation view of a first preferred embodiment of the link device in accordance with the invention;

FIG. 4B is a side view of the FIG. 4A link device;

FIG. 5 is a perspective view of the FIG. 4A link device;

FIG. 6 is a perspective view of a second preferred embodiment of the device in accordance with the invention; and

FIG. 7 is a half-view of a device for positioning a rear abutment of a press bake using a link device of the type shown in FIGS. 1 to 6.

### MORE DETAILED DESCRIPTION

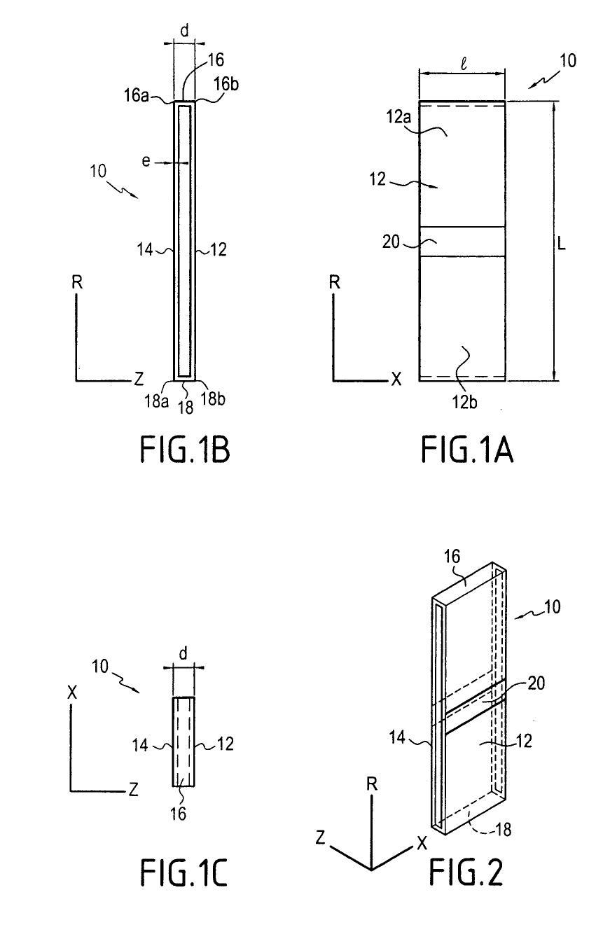

With reference initially to FIGS. 1 to 2, there follows a description of the principle on which the link device is made. It is constituted by two plates 12 and 14 which, in the embodiment described, are rectangular and identical. These plates are of length L in the direction R of the Cartesian frame of reference and of width l in the direction X of the Cartesian frame of reference. The two plates 12 and 14 are connected together at their ends 12a, 14a, 12b, 14b by spacer-forming elements 16 and 18 which extend along the direction Z, in order to keep the plates 12 and 14 parallel to each other when they are at rest. These spacer elements are identical and their respective edges 16a, 16b and 18a, 18b are rigidly secured to the ends of the plates 12 and 14. The plates 12 and 14 have respective central portions 20 constituting zones for securing to the two parts between which the link device 10 is to be mounted.

The plates 12 and 14 and the spacer elements 16 and 18 are preferably made out of the same material, e.g. a metal. The plates 12 and 14 are preferably of substantially constant thickness e and the spacing between the two plates 12 and 14 when held at rest by the spacers 16 and 18 is marked d. Each plate 12, 14 is of dimensions that impart a certain amount of flexibility thereto in the direction of the Cartesian axis Z, and a high level of rigidity in the other directions.

In a particular embodiment, the plates are made of steel having an elastic limit of 355 megapascals (MPa). For each plate, L=300 millimeters (mm); l=80 mm; and e=4 mm. The distance d between the two plates at rest lies in the range 2 mm to 4 mm.

More generally, in order to obtain optimized operation of the link device, it is desirable to satisfy the following dimensional relationships:
80e≦L≦100e
15e≦l≦40e
0.5e≦d≦2e

Finally, if H designates the height over which the plates are actually subjected to bending given the end restraints to which they are subjected, it is desirable to satisfy the following relationship:
15e≦H≦35e

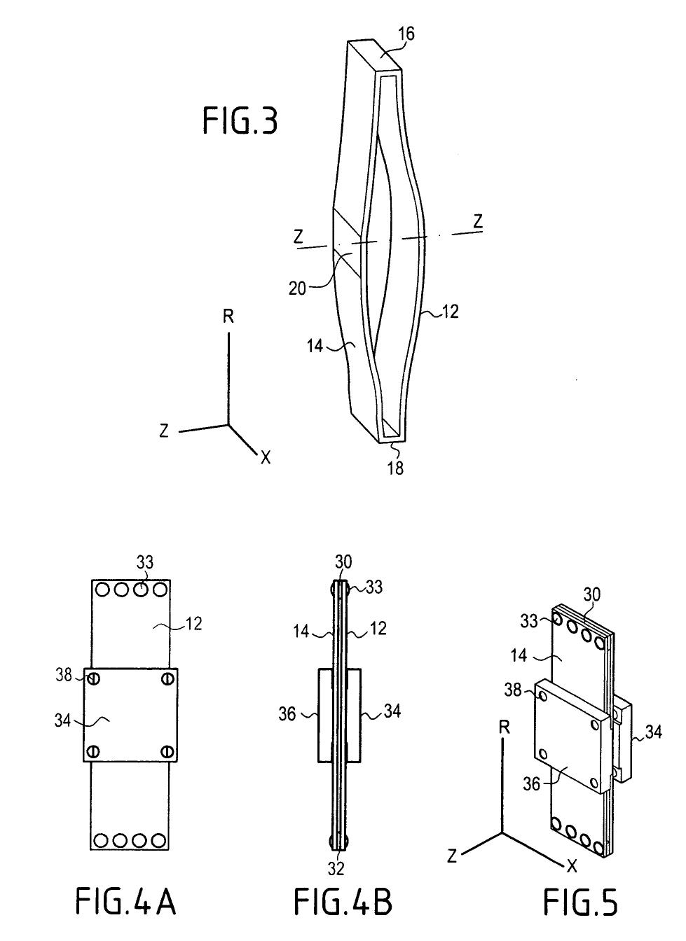

As shown better in FIG. 3, when stresses are applied along the direction z by the parts secured to the plates 12 and 14, the plates can deform in the direction Z, thus allowing the two parts to move relative to each other along said direction Z. In contrast, it will be understood that because of its rigidity that results from the dimensions both of the spacer elements 16 and 18 and of the plates, displacements in Cartesian directions x and R are practically impossible because of the rigidity of the link device in those directions.

In a particular embodiment, each plate presents deformability of ±1.5 mm along the direction Z and rigidity along the other two directions corresponding to a maximum deformation equal to 0.1 mm under a load of 150 kilograms (kg).

Thus, by a structure that is very simple, a link device is indeed obtained presenting the ability to deform in substantially one direction only, along the Cartesian direction Z. In contrast, its capacity for deformation along the other two Cartesian directions R and X are very limited.

With reference to FIGS. 4 and 5, there follows a more detailed description of a first preferred embodiment of the link device. In this embodiment, the spacer elements 16 and 18 are constituted by strips of material preferably identical to that of the plates 12 and 14, and referenced 30 and 32. These strips of material maintain constant space at rest between the plates 12 and 14. In this embodiment, the strips 30 and 32 forming the spacer elements are riveted by means of rivets such as 34. Nevertheless, it is clear that other fastening techniques could be used to unite the spacer elements and the plates, such as welding or adhesive when such techniques provide sufficient connection force, given the stresses that are to be applied to the link device 10. In these figures, there can also be seen interface parts 34 and 36 which are secured to the central portions of the plates 12 and 14 so as to make them easy to secure to the mechanical parts between which the link device is to be interposed. The interface parts 34 and 36 are rectangular for example and secured to the plates by adhesive or by any other suitable technique. Preferably, each of the interface parts 34 and 36 constitutes a kind of flange with fastening holes such as 38 for fastening the two parts that are associated with the link device.

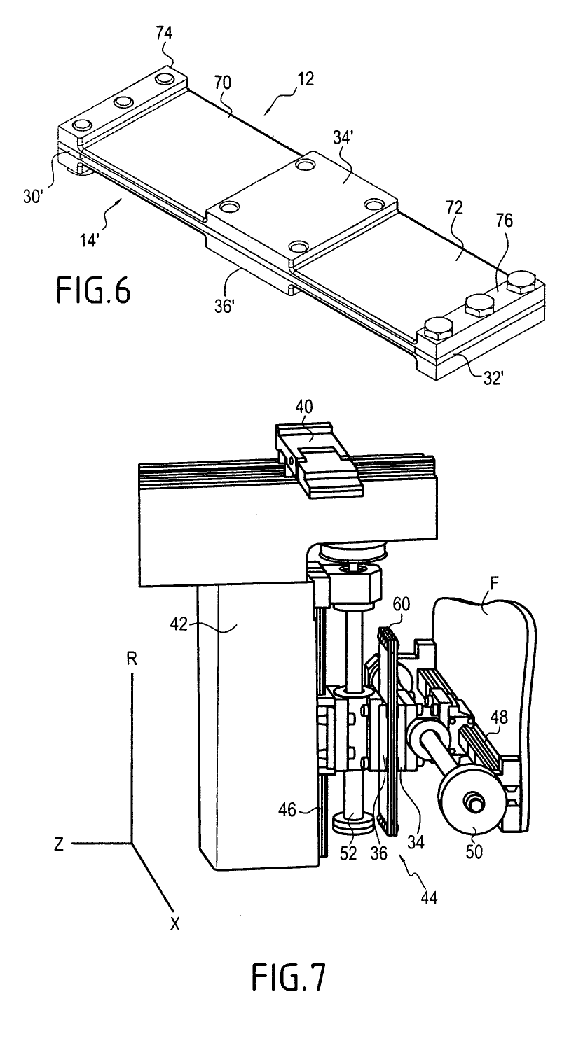

FIG. 6 shows a second preferred embodiment of the link device.

Each plate 12′, 14′ is machined out of a thicker plate so as to reduce the intermediate portions 70, 72 of each plate to the desired thickness e, while leaving extra thickness in a central portion 34′, 36′ constituting the interface parts and at the end portions 74 and 76 where they are to be rigidly secured to the spacer elements 30′ and 32′. The spacer elements 30′ and 32′ are preferably secured to the ends of the plates via their thicker portions 74 and 76 by means of screws such as 33′. This ensures a very rigid connection between the ends of the plates 12′ and 14′ via the spacer elements 30′ and 32′.

Naturally, the link device shown in FIG. 6 preferably satisfies the geometrical relationships set out above.

FIG. 7 is a perspective view of an example of the link device as shown in FIGS. 1 to 5 being used for the purpose of positioning the rear abutment of a press brake.

The function of the rear abutment of a press brake is to ensure that the edge of a metal sheet is accurately positioned prior to being machined in the press brake. The rear abutments such as 40 are mounted on a support 42 which is guided in translation along the Cartesian directions R and X relative to cheek plates F of the structure. For this purpose, a drive motor assembly 44 is provided at each end of the support 42 of the rear abutment 40 between each of its sides and the cheek plates F of the structure of the machine. By their construction, the support 42 and the cheek plates F are very rigid. More precisely, two guide rails such as 46 are mounted on the sides of the support 42, the rails extending the direction R, and two guide rails 48 are secured to each cheek plate F, these rails extending in the direction X. Drive members 50 enable the link assembly 44 to be moved relative to the rail 48 along the direction X, and second drive members 52 enable the support 42 for the rear abutment 40 to be moved along the direction R relative to the link assembly 44. Thus, the support 42 for the rear abutment 40 can be moved relative to the structure of the machine along the directions R and X.

In order to compensate for possibly inadequate tolerance in the guide means constituted by the rails 46 and 48, a link device 60 of the type described with reference to FIGS. 1 to 5 is interposed between the drive members 50 and 52. The device 60 is mounted in such a manner that the plates 12 and 14 constituting it lie in the RX plane. Their interface parts 34 and 36 are used for fastening respectively to the drive members 50 and 52.

It can thus be understood that because of the capabilities of the link device 60 in deformation, tolerance errors in the guide means for providing guidance along the directions R and X can be compensated by deforming the link device in the direction Z. In contrast, the entire system interposed between the guide rails 46 and 48 presents great rigidity in the directions R and X.

What is claimed is:

1. A link device for connecting two parts together and that is deformable in substantially one direction only, the device comprising:
two plane, substantially identical elastically deformable plates of thickness that is substantially constant in their deformable portions, each plate presenting two opposite ends; and
two spacer elements for interconnecting the corresponding ends of the two plates while providing rigid end restraint and for holding them substantially parallel while at rest, no other mechanical link existing between the two plates, each part being suitable for being secured to a respective one of the plates;
whereby the two parts can move relative to each other significantly in the direction orthogonal to the two plates, while relative movements between them are very limited in the other two directions of a Cartesian frame of reference.

2. A link device according to claim 1, wherein said spacer elements extend over the entire lengths of the ends of said plates.

3. A link device according to claim 1, wherein said plates are substantially rectangular.

4. A link device according to claim 3, wherein the spacer elements interconnect the corresponding short sides of the two plates.

5. A link device according to claim 4, wherein said spacer elements extend over the full length of said short sides.

6. A link device according to claim 3, wherein each spacer-forming element is constituted by a strip of rigid material interposed between the two plates along their short sides, and wherein the strips of material are fastened to the plates by riveting.

7. A link device according to claim 1, wherein each plate includes fastener means for fastening to a respective one of said parts, said fastener means occupying the middle zone of the outside face of the corresponding plate.

8. A link device according to claim 7, wherein the fastener means for fastening to the parts comprise two rigid interface members fastened respectively in the middle zone of each plate.

9. A device according to claim 1, wherein the total length of each plate L lies in the range 80e to 100e, where e is the thickness of a plate.

10. A device according to claim 1, wherein the width l of a plate lies in the range 15e to 40e, where e is the thickness of the plate.

11. A device for positioning the rear abutment of a press brake having two stationary cheek plates and a moving support for said abutment, said device comprising two guide rails secured to said cheek plates parallel to a first direction, two second guide rails secured to each side of said support and parallel to a second direction orthogonal to said first direction, two drive motor assemblies, each assembly being interposed between a first guide rail and a second guide rail, each assembly comprising a first drive member for moving said assembly relative to the first rail and a second drive member for moving said second rail relative to said assembly, link assembly comprising a link device comprising:
two plane, substantially identical elastically deformable plates of thickness that is substantially constant in their deformable portions, each plate presenting two opposite ends; and
two spacer elements for interconnecting the corresponding ends of the two plates while providing rigid end restraint and for holding them substantially parallel while at rest, no other mechanical link existing between the two plates, each part being suitable for being secured to a respective one of the plates; interposed between said first and second drive members in such a manner that said plates of the link device are parallel to the planes defined by said first and second directions.
